(19) United States
(12) Patent Application Publication
(10) Pub. No.: US 2015/0118966 A1
(43) Pub. Date: Apr. 30, 2015

(54) SECURE TAP TO TRANSFER OBJECTS

(71) Applicant: Lenovo (Singapore) Pte. Ltd., Singapore (SG)

(72) Inventors: Howard Locker, Cary, NC (US); Daryl Cromer, Cary, NC (US); Richard Wayne Cheston, Pittsboro, NC (US); Randall Scott Springfield, Chapel Hill, NC (US)

(73) Assignee: Lenovo (Singapore) Pte. Ltd., Singapore (SG)

(21) Appl. No.: 14/066,995

(22) Filed: Oct. 30, 2013

(51) Int. Cl. H04W 4/00; H04L 29/06

(52) U.S. Cl. CPC H04W 4/008; H04L 63/0492
USPC 455/41.2

(57) ABSTRACT

An embodiment provides a method, including: detecting two devices are proximate to one another utilizing a device component; comparing received device motion information to a predetermined motion; and after matching the received device motion information to a predetermined motion, transferring an object between the two devices. Other aspects are described and claimed.

### BACKGROUND

Information handling devices (“devices”), for example laptop computers, tablets, smart phones, e-readers, etc., may be used to interact with other devices. Mobile devices commonly share information over some type of network connection. Wireless mesh networks may be used in this regard.

Wireless mesh networks provide a distributed connection area or mesh using a plurality of mesh nodes or devices. In contrast to more traditional networks that utilize a relatively small number of hotspots/access points to connect devices to a network, a wireless mesh network provides connectivity by distributing connectivity, including broader network access, among many wireless mesh nodes in communication with one another. Thus, the mesh network may be used to share objects, e.g., data, files, etc., among devices connected via the mesh network.

In terms of sharing objects, devices may be physically tapped or bumped together to pair devices using near field communication for a transfer of an object between devices. The object is thus transferred, e.g., using a network communication, commonly WiFi and/or BLUETOOTH communication or even near field communication (NFC).

### BRIEF SUMMARY

In summary, one aspect provides a method, comprising: detecting two devices are proximate to one another utilizing a device component; comparing received device motion information to a predetermined motion; and after matching the received device motion information to a predetermined motion, transferring an object between the two devices.

Another aspect provides an information handling device, comprising: a processor; and a memory device storing instructions executable by the processor to: detect two devices are proximate to one another utilizing a device component; compare received device motion information to a predetermined motion; and after matching the received device motion information to a predetermined motion, transfer an object between the two devices.

A further aspect provides a program product, comprising: a storage medium comprising computer readable program code, the computer readable program code comprising: computer readable program code configured to detect two devices are proximate to one another utilizing a device component; computer readable program code configured to compare received device motion information to a predetermined motion; and computer readable program code configured to, after matching the received device motion information to a predetermined motion, transfer an object between the two devices.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of an information handling device.

FIG. 3 illustrates an example method for secure object transfer between devices.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

One of the benefits of a mesh network or device to device communication is access to the objects (e.g., data, files (e.g., video, music), etc.) across devices, e.g., actively part of the mesh network at a given moment in time. An existing method for highly mobile devices to share information is to bump or tap into each other. There are various methods to bump two highly mobile devices together and after the successful bump pass information and/or data from one device to the other. The bump gets both devices close enough to pass information, e.g., via near field communication technology. The bump or tap brings the devices proximate to one another for pairing the two devices, e.g., NFC. Once paired, the devices pass information, e.g., share object(s) usually via a personal area network (PAN) such as BLUETOOTH and/or WiFi Direct (MIRACAST) technologies, although the transfer may be accomplished with NFC, e.g., depending on the amount of data to be transferred.

However, this method of object transfer is not very secure. For example, a user may leave his or her device, e.g., at a desk, and an unauthorized user could take the device and bump their device against it, thereby transferring information between devices. Another problem with using a simple tap or bump as a trigger for object transfer is that there is no way to send different levels of permission during the bump or tap operation. Accordingly, what is needed is a more secure tap transfer method, with the possibility of having different levels of permission or granularity connected with the transfer.

An embodiment requires the user to move the device (e.g., smart phone, tablet, etc.) in three dimensional (3D) space in a specified motion, which may include a unique motion pattern or orientation, e.g., prior to the pairing of the devices (e.g., via bump or tap). The object (e.g., data, file, etc.) will only be sent to the second device if the user initiated motion is a match with the specified motion, e.g., stored as motion pattern or orientation information.

The illustrated example embodiments will be best understood by reference to the figures. The following description is intended only by way of example, and simply illustrates certain example embodiments.

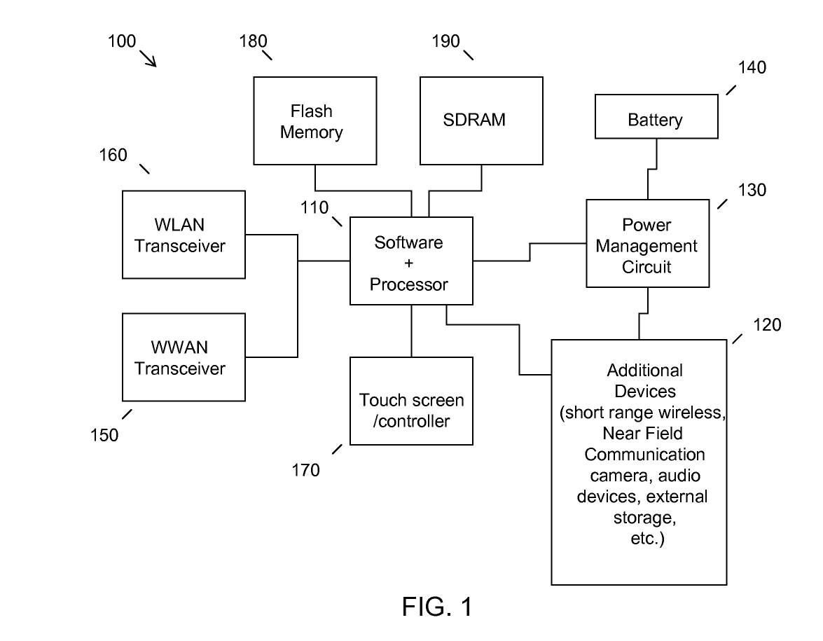

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces for example include SDIO and I2C.

There are power management chip(s) 130, e.g., a battery management unit, BMU, which manage power as supplied for example via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, one of the additional devices 120 is commonly a short range wireless communication device, such as a BLUETOOTH radio that may be used for near field communications, e.g., among devices communicating via a mesh network or device to device communication arrangement. Commonly, system 100 will include a touch screen 170 for data input and display. System 100 also typically includes various memory devices, for example flash memory 180 and SDRAM 190.

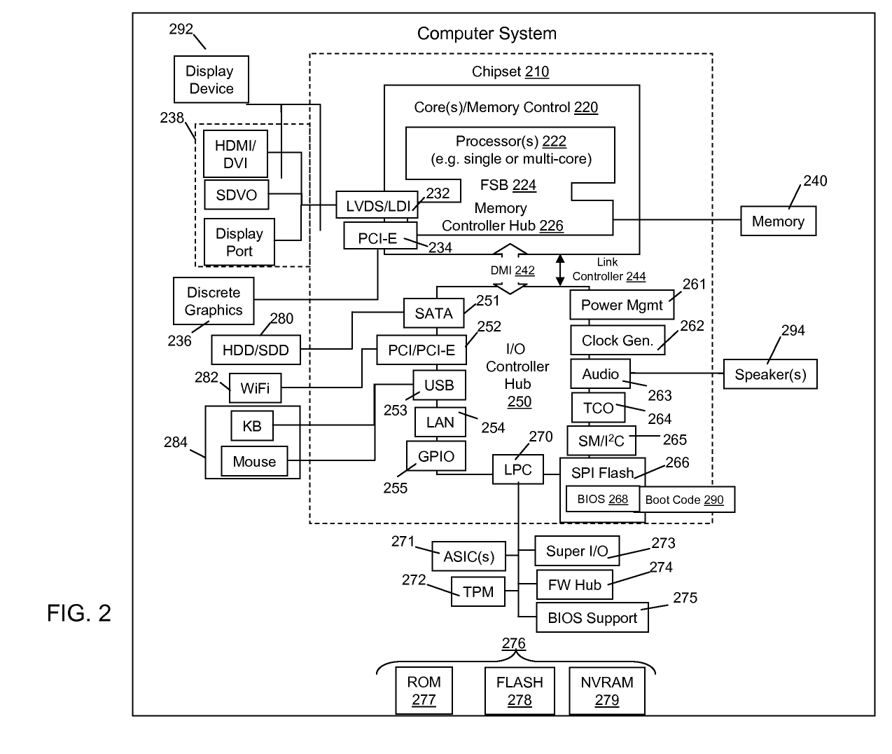

FIG. 2, for its part, depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). The architecture of the chipset 210 includes a core and memory control group 220 and an I/O controller hub 250 that exchanges information (for example, data, signals, commands, et cetera) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, et cetera). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, 280 et cetera), a PCI-E interface 252 (for example, for wireless connections 282), a USB interface 253 (for example, for devices 284 such as a digitizer, keyboard, mice, cameras, phones, microphones, storage, other connected devices, et cetera), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may used in devices that are tapped or bumped to transfer information, e.g., using near field communication. Accordingly, using such a device, a user may bump another device to transfer the object of interest (e.g., data, audio file, video file, etc.). In an embodiment, a security step is added requiring additional information prior to transferring the object in question between the devices.

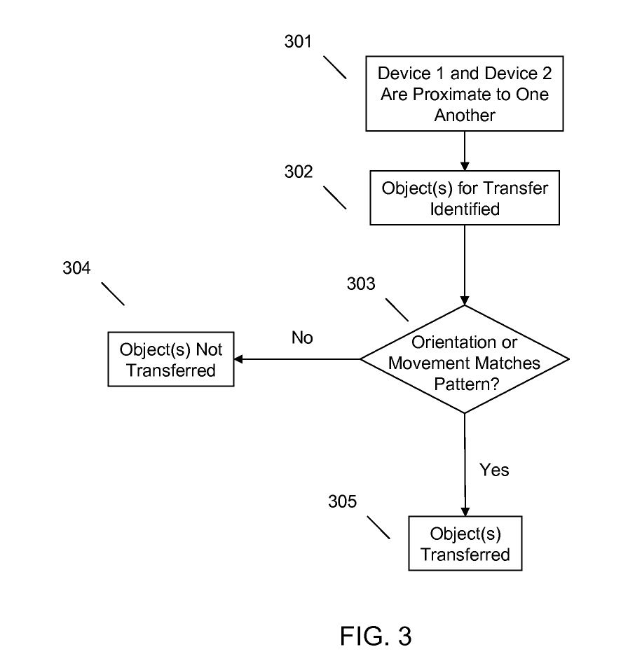

As an example, referring to FIG. 3, considering two mobile devices (e.g., device 1 and device 2), these devices may be brought proximate to one another or bumped/tapped at 301. This permits the devices to be paired with one another in order to transfer object(s). Conventionally, this is all that is required in order to transfer information/object(s) of interest between the two devices according to various tap or bump transfer applications. Thus, conventionally device 1 and device 2 may exchange information following the tap, e.g., via near field communication, after the object(s) to be transferred are identified 302. The transfer of the object(s) between devices may take at various times after the devices are paired, e.g., immediately or later, such as in response to a trigger.

However, in an embodiment, an additional requirement is imposed prior to committing the object transfer in view of making the transfer mechanism more secure. Thus, at 303 an embodiment, prior to transferring the object(s) between devices, determines if a movement pattern matches an expected movement pattern at 303. For example, at 303 it is determined if the user of device 1 has moved device 1 (e.g., smart phone, tablet, etc.) in three dimensional (3D) space in a unique pattern. This movement may occur at a predetermined time, e.g., prior to the bump or tap, thereafter, or both. The object(s) (e.g., data, file, etc.) will only be sent to the other device, e.g., device 2, if the user initiated motion is a match with the unique pattern at 303. The expected unique pattern may be predetermined and defined by the user, e.g., by performing the movement and storing it as a lock pattern, etc.

An embodiment therefore functions akin to a dial lock where a user must turn a dial in a predetermined patter, e.g., left a certain amount, then right a certain amount, then left a certain amount, etc., to form a combination. In an embodiment, a similar movement pattern may be utilized, e.g., as ascertained via an accelerometer or like device component(s) available on mobile devices. The pattern can be as simple as just a left rotation X degrees, right rotation Y degrees, then left rotation X degrees, or may be more complex. The device may use its components (e.g., compass, gyroscope, accelerometer, or some suitable combination of components) to determine if the user initiated motion pattern matches the stored pattern.

Additionally or in the alternative, a unique orientation may be required, e.g., as sensed through a device component. For example, a device may be required to be positioned in a certain orientation in three dimensional space (e.g., utilizing information derived from a gyroscope) or facing a certain direction, e.g., north, as sensed via a compass of the device, prior to permitting the object(s) to be transferred.

In other examples, the pattern may be more complex, e.g., involving movement before and after the bump or tap, or even including movement of both devices. For example, the pattern required prior to transfer at 303 may be extended to require the receiving device (e.g., device 2) to also have a unique matching movement pattern, as ascertained e.g., at 303. Thus, both devices (and therefore users handling the devices) need to approve the object(s) transfer at 303. This, for example, provides that no user may insert or transfer an object into another user's device without the other user's approval, e.g., as ascertained via detecting an appropriate pattern of movement in 3D space.

Moreover, the pattern matched at 303 may be multi-factor or associated with different transfer permissions, e.g., for different objects or information. For example, an embodiment may require different motion patterns at 303 for the transferring different objects or objects of different quality (e.g., time limited, non-transferable to third party devices, of a particular format, e.g., read only, etc.). In a similar way as a single pattern, the various patterns associated with varying levels of transfer permissions may be simple or complex, e.g., involving one or more device movements or movements of one or more device, and/or with different timing (e.g., before a tap or bump, after a tap or bump, or suitable combinations thereof).

A non-limiting example includes requiring one pattern at 303 where the receiving device gets relevant information but does not get the required information to allow it to send an object to other devices. Another pattern required at 303 may give the receiving device the ability to allow it to send the object to other devices. Thus, there may be a multitude of patterns required at 303, each having different effects on the object transfer and follow along capabilities (e.g., giving the receiving device different permissions with respect to information received, transmitted, or later transmitted to other devices).

Following a failed match, the objects may not be transferred at 304. Otherwise, if the received pattern or patterns are a match, the object(s) may be transferred between devices. As will be apparent from the description here, the requirement of various pattern(s) may be used to add security to the tap or bump transfer applications such that users retain greater control over objects and information that is retrieved from or transmitted to their devices.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting two devices are proximate to one another utilizing a device component;
comparing received device motion information to a predetermined motion; and
after matching the received device motion information to a predetermined motion, transferring an object between the two devices.

2. The method of claim 1, wherein the predetermined motion is obtained by accessing a store of device motion information.

3. The method of claim 1, wherein the comparing consists of an orientation comparison.

4. The method of claim 1, further comprising:
determining timing information of received device movement information; and
comparing the timing information of the device movement information to expected timing information;
wherein the transferring is not performed if the timing information does not match the expected timing information.

5. The method of claim 1, wherein the device motion information comprises device motion information of a device selected from an object transferring device and an object receiving device.

6. The method of claim 1, wherein the device motion information comprises device motion information of both the object transferring device and the object receiving device.

7. The method of claim 1, further comprising:
determining a permission level associated with the predetermined motion; and
determining if the permission level matches the object to be transferred;
wherein the transferring is not performed if the permission level does not match the object.

8. The method of claim 7, wherein the permission level determines a quality of the object to be transferred.

9. The method of claim 3, wherein the two devices are paired responsive to matching the received device orientation information to a predetermined orientation.

10. The method of claim 1, wherein the transferring an object between the two devices comprises transferring the objects wirelessly using short range device to device communication.

11. An information handling device, comprising:
a processor; and
a memory device storing instructions executable by the processor to:
detect two devices are proximate to one another utilizing a device component;
compare received device motion information to a predetermined motion; and
after matching the received device motion information to a predetermined motion, transfer an object between the two devices.

12. The information handling device of claim 11, wherein the predetermined motion is obtained by accessing a store of device motion information.

13. The information handling device of claim 11, wherein to compare consists of an orientation comparison.

14. The information handling device of claim 11, wherein the instructions are further executable by the processor to:
determine timing information of received device movement information; and
compare the timing information of the device movement information to expected timing information;
wherein transferring is not performed if the timing information does not match the expected timing information.

15. The information handling device of claim 11, wherein the device motion information comprises device motion information of a device selected from an object transferring device and an object receiving device.

16. The information handling device of claim 11, wherein the device motion information comprises device motion information of both the object transferring device and the object receiving device.

17. The information handling device of claim 11, wherein the instructions are further executable by the processor to:
determine a permission level associated with the predetermined motion; and
determine if the permission level matches the object to be transferred;
wherein transferring is not performed if the permission level does not match the object.

18. The information handling device of claim 17, wherein the permission level determines a quality of the object to be transferred.

19. The information handling device of claim 13, wherein the two devices are paired responsive to matching the received device orientation information to a predetermined orientation.

20. A program product, comprising:
a storage medium comprising computer readable program code, the computer readable program code comprising:
computer readable program code configured to detect two devices are proximate to one another utilizing a device component;
computer readable program code configured to compare received device motion information to a predetermined motion; and
computer readable program code configured to, after matching the received device motion information to a predetermined motion, transfer an object between the two devices.
